(19) United States
(12) Patent Application Publication
(10) Pub. No.: US 2018/0107434 A1
(43) Pub. Date: Apr. 19, 2018

(54) PRINT DATA INSPECTION DEVICE, PRINT DATA INSPECTION SYSTEM, AND NON-TRANSITORY COMPUTER READABLE MEDIUM

(71) Applicant: FUJI XEROX CO., LTD., Tokyo (JP)

(72) Inventor: Takeshi FUKUI, Kanagawa (JP)

(73) Assignee: FUJI XEROX CO., LTD., Tokyo (JP)

(21) Appl. No.: 15/649,595

(22) Filed: Jul. 13, 2017

(30) Foreign Application Priority Data
Oct. 18, 2016 (JP) 2016-204159

(51) Int. Cl. G06F 3/12

(52) U.S. Cl. CPC G06F 3/121; G06F 3/1206; G06F 3/125; G06F 3/1231; G06F 3/1234; G06F 3/1248

(57) ABSTRACT

A print data inspection device includes a specification unit that specifies a finish area and a bleed area from page setting information of print data, and a processing unit that executes a process for notifying a user of an error in a case where at least a portion of the finish area is located outside of the bleed area.

### CROSS-REFERENCE TO RELATED APPLICATIONS

This application is based on and claims priority under 35 USC 119 from Japanese Patent Application No. 2016-204159 filed Oct. 18, 2016.

### BACKGROUND

### (i) Technical Field

The present invention relates to a print data inspection device, a print data inspection system, and a non-transitory computer readable medium.

### (ii) Related Art

In production printing for business use, image data including bleed, a trim mark or the like is printed on paper in consideration of trimming. Some page description languages (PDL) such as a portable document format (PDF) representing printable image data have a structure for representing a finish area or the like remaining after bleeding or trimming. For example, the PDF has an attribute of TrimBox indicating a finish area, BleedBox indicating a bleed area, or the like, as setting information of a page.

### SUMMARY

Originally, a bleed area and a finish area is to be set to have a positional relationship in which the former completely includes the latter therein. However, as a positional relationship in which TrimBox and BleedBox are to be satisfied is not specified in, for example, the rule of PDF, there are some PDLs that do not specify a positional relationship between these both. There may be some pieces of print data described in such PDLs in which a bleed area and a finish area are not set to have an original correct positional relationship described above. For example, even in a case where the bleed area and the finish area are set to have an inappropriate positional relationship due to an erroneous operation, a defect of software, or the like, this is likely to be incorporated into print data as a correct setting in terms of the rule of a page description language. Printing of print data in which the bleed area and the finish area are set to have an inappropriate positional relationship may give rise to unexpected print results of a correct finish object not being able to be obtained.

According to an aspect of the invention, there is provided a print data inspection device including: a specification unit that specifies a finish area and a bleed area from page setting information of print data; and a processing unit that executes a process for notifying a user of an error in a case where at least a portion of the finish area is located outside of the bleed area.

### BRIEF DESCRIPTION OF THE DRAWINGS

Exemplary embodiment(s) of the present invention will be described in detail based on the following figures, wherein:

FIG. 1 is a diagram illustrating an example of a system configuration of an exemplary embodiment;

FIG. 2 is a diagram illustrating various types of areas relating to a page which are indicated by page setting information of print data;

FIG. 3 is a diagram illustrating an example in a case where a positional relationship between a finish area and a bleed area is inappropriately set;

FIG. 4 is a diagram illustrating a functional element group for the inspection of the page setting information among functional elements included in a print control device;

FIG. 5 is a diagram illustrating an example of a processing procedure which is performed by a determination unit;

FIG. 6 is a diagram illustrating an example of a procedure of the specification of the finish area;

FIG. 7 is a diagram illustrating an example of an error notification screen displayed in a case where a positional relationship between the finish area and the bleed area is determined to be inappropriate; and

FIGS. 8A and 8B are diagrams illustrating an example in a case where a positional relationship between the finish area or the bleed area and a display area is inappropriate, in a case where one of the finish area or the bleed area is not set in the page setting information, and the display area is set therein.

### DETAILED DESCRIPTION

An example of a system configuration of the present exemplary embodiment will be described with reference to FIG. 1.

This system includes a print control device 10, a print device 20, a client device 30, and a display device 35.

This system is a system used for printing service such as, for example, commercial printing or industrial printing, prints out print data received from a client in accordance with settings requested by the client, and performs post-processing such as binding.

The print control device 10 is a device that performs control for causing the print device 20 to print the input print data, and is a kind of print server (also called a digital front end). The print control device 10 performs, for example, processes such as the execution management of jobs (management such as, for example, the execution order or reprinting of jobs), the management of settings of individual jobs (for example, reception of input or change of settings of the number of copies or the size of paper), an imposition process, a color matching process, a conversion process of converting print data (described in a page description language) into image data of a data format (for example, raster format) which can be handled by the print device 20, the provision of a preview image of a print result according to settings, preflight (check of the presence or absence of an error relating to various types of settings), and the management of test print. Various types of processes exemplified herein are merely illustrative. The print control device 10 may not execute all these processes, and may execute processes other than these processes. In a case where the print control device 10 receives a print instruction for a job or an instruction for test print from a user, the print data is converted into a data format which can be handled by the print device 20 in accordance with the setting of the job, and data of the conversion result is delivered to the print device 20 to cause the print device to execute printing. In addition, the print control device 10 provides some or all of settings of the job, as control information of a format which can be handled by the print device 20, to the print device 20. In addition, the print control device 10 provides information of a user interface (UI) screen for print management to the client device 30, and receives an input from a user relating to the UI screen. Examples of the UI screen include an input screen of various settings for printing, a designation screen of imposition, a preview screen, a screen indicating the result of preflight, and the like.

The print device 20 prints data received from the print control device 10, on a medium such as paper, in accordance with the control information from the print control device 10.

The client device 30 is a computer (for example, a personal computer) which is operated by a user (for example, staff of a company who contracts for printing service from a client). The client device 30 displays a UI screen generated on the basis of the UI screen information provided from the print control device 10 on the accessory display device 35, receives an input from a user relating to the UI screen, and transmits the input to the print control device 10.

Meanwhile, the system configuration shown in FIG. 1 is merely illustrative. The print control device 10 itself may include a display device and an input device, and provide a UI to a user. In addition, the print control device 10 and the print device 20 may be mounted within one housing.

Incidentally, the print control device 10 has a function of detecting the unconformity of page setting information (page size setting) of the print data. The function will be exemplified below.

Among the data formats of the print data, there is a format capable of setting plural areas (that is, plural page sizes) with respect to a page even in consideration of use in commercial printing or the like. For example, a portable document format (PDF) is an example thereof. In a case of the PDF, five areas (page sizes) of MediaBox, CropBox, BleedBox, TrimBox, and ArtBox can be set.

The MediaBox is an attribute for specifying a rectangle (also called a “medium area”) indicating the size of a physical medium (for example, paper) having a page drawn thereon, and the value is requisite.

The CropBox is a rectangle (also called a “display area”) indicating a clipping (display) range in a case where a page is displayed on a screen or is printed using a general printer. In ADOBE READER (Registered Trademark) or ACROBAT (Registered Trademark) which is Adobe's PDF viewer software, this CropBox is used as a display range in a case where a page is displayed, or a print range in a case where a page is printed using a general printer which is not used for printing service.

The BleedBox is a rectangle (hereinafter, also called a “bleed area”) indicating a range which is printed in a system for production (commercial/industrial printing), and is generally a size including a trim mark, bleed or the like around the TrimBox. In production printing, since a design such as a photograph is disposed to the end of a finish page, even a bleed portion located outside of a final finish area (TrimBox) is printed, and the bleed portion is finally bled by trimming, to thereby generate a finish object.

The TrimBox is a rectangle (hereinafter, also called a “finish area”) indicating the range of a finish page after trimming.

The ArtBox is a rectangle indicating a range having meaningful page contents of a graphic object or the like.

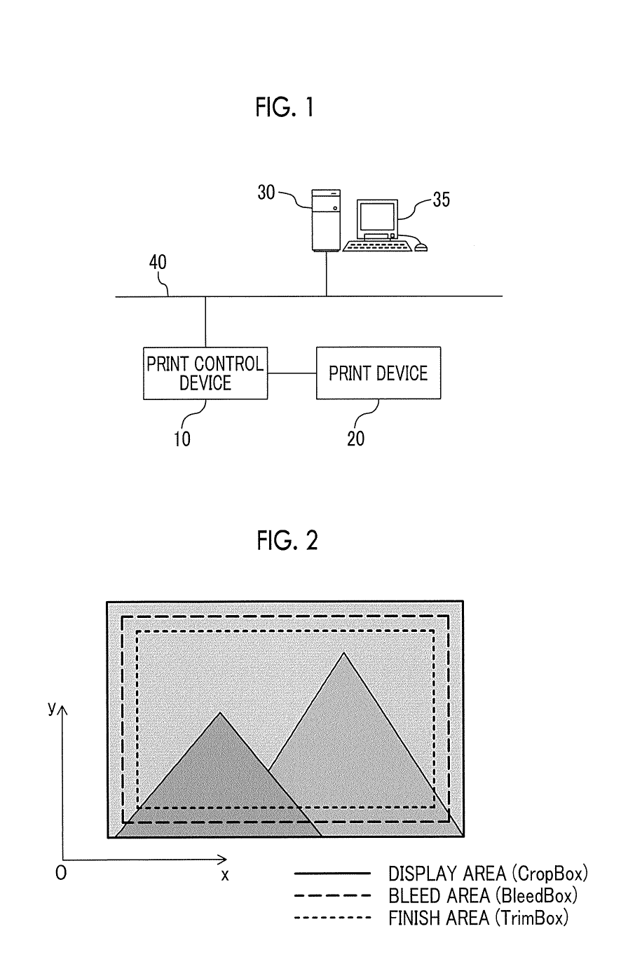

In a case of the PDF, the MediaBox, the CropBox, the BleedBox, the TrimBox, and the ArtBox are represented by a set of coordinates of a lower left vertex and coordinates of an upper right vertex of each rectangle. For example, as shown in FIG. 2, the coordinate system of a page is configured such that, in a case where the traverse direction of the page is set to an x-axis and the longitudinal direction thereof is set to a y-axis, an x coordinate increases toward the right side of the page, and a y coordinate increases toward the upper side thereof.

The MediaBox, the CropBox, the BleedBox, and the TrimBox are often set in a file of print data of a PDF format created for production. In this case, a typical size relationship between these page areas is MediaBox≥CropBox≥BleedBox≥TrimBox.

Meanwhile, since settings are arbitrary with the exception of the medium area (MediaBox), print data in which the bleed area (BleedBox) or the finish area (TrimBox) is not set is also present. In a case where the bleed area (BleedBox) or the finish area (TrimBox) is not set, the print control device 10 analyzes the display area (CropBox) or the medium area (MediaBox) as the bleed area or the finish area to execute a process.

Information of each page within a PDF file forms a tree structure. The root of this tree structure is a root object, and is called a document catalog. The document catalog has an object called a page tree node as a child. The page tree node may have a page object and a page tree node as a child. The page object is an object indicating an individual page, and includes setting information (attribute information) of various types of page areas (page sizes) or the like, information indicating page contents, and the like. Data of the page contents may be included within the page object in the form of stream data or the like, and may also be included within another object as an indirect object. In a case of the latter, the page object includes information denoting a stream object indicating page contents. The setting information of various types of page areas of the aforementioned MediaBox or the like is set in the page tree node or the page object. In a case where these values are set in an ancestor node on a page tree, values inherited from the ancestor node are used unless the values are not overwritten.

FIG. 2 shows a positional relationship between the bleed area (BleedBox) and the finish area (TrimBox) which are appropriately set with respect to images of mountains. As shown in the figure, from a meaning of bleed, the finish area is completely included in the bleed area. In addition, the display area (CropBox) is often set so as to include the bleed area.

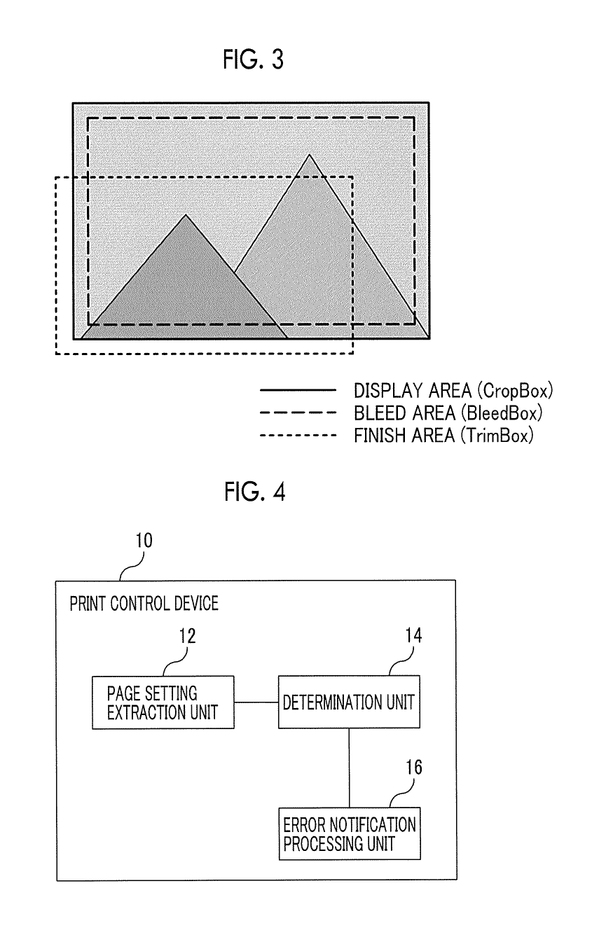

Meanwhile, in the rule of PDF, since a positional relationship between the BleedBox and the TrimBox is not specified, print data having a setting deviating from an appropriate positional relationship illustrated in FIG. 2 may be generated. FIG. 3 shows an example in a case where such a positional relationship between the BleedBox and the TrimBox is inappropriately set. In this example, a portion of the TrimBox protrudes to the outer side of the BleedBox. In addition, although not shown in the figure, the positional relationship is inappropriate even in a case where the entire TrimBox is located outside of the BleedBox, or a case where the BleedBox is completely included inside of the TrimBox.

In the field of commercial/industrial printing, people's hands playing various roles are passed through until one piece of print data is complete. Therefore, one person of the people performs an erroneous operation, or there is a defect in an application used by someone of the people in order to handle the print data, so that the positional relationship between the BleedBox and the TrimBox may be set to such an inappropriate relationship.

In a case where the TrimBox and the BleedBox are set to have an appropriate positional relationship illustrated in FIG. 2, the print data conversion (for example, rasterizing) function of the print control device 10 may generate image data of a range of the BleedBox in a page of print data. An assumed finish object is obtained by bleeding the outer side of the TrimBox in the range of the printed BleedBox.

On the other hand, in a case where the TrimBox and the BleedBox are set to have an inappropriate positional relationship illustrated in FIG. 3, the print data conversion function generates image data of an inappropriate print range which is not intended, and thus the image data is printed. For example, in a case of the positional relationship illustrated in FIG. 3, the print data conversion function of the print control device 10 of a certain model generates image data of a portion in which the TrimBox and the BleedBox overlap each other. In a case where the TrimBox and the BleedBox have an inappropriate positional relationship, what kind of image is generated depends on how the handling of the TrimBox and the BleedBox is mounted (programmed) in the print data conversion function, which leads to an unpredictable result. In anyway, in a case where the TrimBox and the BleedBox are set to have an inappropriate positional relationship, the TrimBox and the BleedBox do not fulfill a role assumed originally, and thus it is not possible to derive an appropriate print range considering trimming from settings of these both. In a case where print data is printed in a state of such erroneous settings, the print result leads to a waste sheet.

In order to cope with such a problem, the print control device 10 of the present exemplary embodiment has a function of confirming whether the positional relationship between the bleed area (BleedBox) and the finish area (TrimBox) which are set in the print data is appropriate. FIG. 4 shows an element group relating to such a confirmation function among functional elements included in the print control device 10.

The page setting extraction unit 12 extracts page setting information which is setting information of a page area such as a bleed area, from print data to be processed. In a case where plural pieces of page setting information are included in one piece of print data (in a case where page setting information is present, for example, for each page or for each group of a page), the plural pieces of page setting information are extracted.

The determination unit 14 determines whether the positional relationship between the bleed area (BleedBox) and the finish area (TrimBox) is appropriate, for each piece of page setting information extracted from the print data, in the setting of a page area included in the page setting information.

In a case where the determination unit 14 determines that the positional relationship between the bleed area (BleedBox) and the finish area (TrimBox) is inappropriate, the error notification processing unit 16 performs a process for providing an error notification to a user.

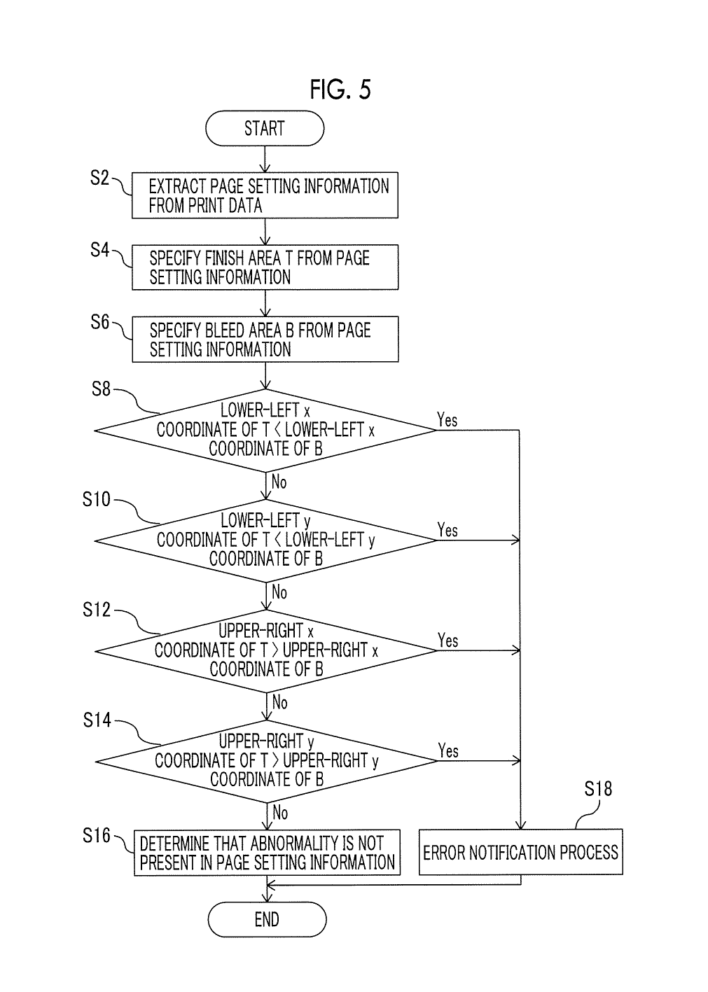

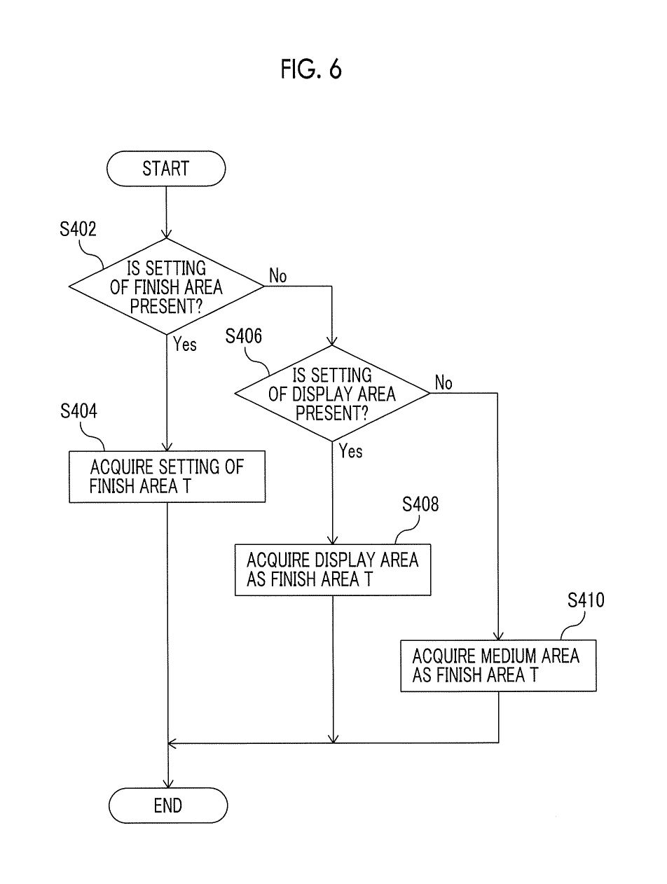

An example of a processing procedure of the present exemplary embodiment will be described with reference to FIGS. 5 and 6.

In a case where an instruction of the confirmation of page setting is input from a user with respect to print data to be processed, the page setting extraction unit 12 extracts the page setting information from the print data (S2).

Next, the determination unit 14 specifies a finish area T and a bleed area B from the extracted page setting information (S4 and S6).

An example of a procedure of the specification of the finish area T performed in S4 shown in FIG. 6. In this procedure, the determination unit 14 determines whether the setting of the finish area (TrimBox) is included in the page setting information (S402). In a case where the setting of the finish area is present, the setting is acquired, and is used as the finish area T in the following process (S404).

In a case where the setting of the finish area (TrimBox) is not present in the page setting information, the determination unit 14 determines whether the setting of the display area (CropBox) is present in the page setting information (S406). In a case where the setting of the display area is present, the setting is acquired, and is used as the finish area T in the following process (S408).

In a case where the setting of the display area (CropBox) is not present in the page setting information, the determination unit 14 acquires the setting of the medium area (MediaBox) included in the page setting area, and the setting is used as the finish area T in the following process (S410). In a case of the print data of PDF, the MediaBox is necessarily included.

As stated above, the procedure of specifying the finish area T is exemplified, the bleed area B may also be specified in the same procedure. That is, for example, in a case where the setting value of the bleed area (BleedBox) is included in the page setting information, this value is used as the bleed area B in the following process. In a case where the setting value is not included, the display area (CropBox) is used as the bleed area B. In a case where the setting value of the display area (CropBox) is also not included, the setting value of the medium area (MediaBox) is used as the bleed area B.

Referring back to the description of FIG. 5, in a case where the finish area T and the bleed area B are specified in S4 and S6, the determination unit 14 next performs the determinations of S8, S10, S12, and S14. The order of these four determinations may be performed in any order.

In S8, the determination unit 14 compares x coordinates of the lower left vertices of the finish area T and the bleed area B, and determines whether the former is smaller than the latter (that is, the lower left vertex of the finish area T is located on the left side of the lower left vertex of the bleed area B). In a case where this determination result is positive (Yes), the lower left vertex of the finish area T is located outside of the rectangle of the bleed area B. This corresponds to an inappropriate positional relationship.

In S10, the determination unit 14 compares y coordinates of the lower left vertices of the finish area T and the bleed area B, and determines whether the former is smaller than the latter (that is, the lower left vertex of the finish area T is located on the lower side of the lower left vertex of the bleed area B). In a case where this determination result is positive (Yes), the lower left vertex of the finish area T is located outside of the rectangle of the bleed area B. This corresponds to an inappropriate positional relationship.

Incidentally, in the finish area and the bleed area illustrated in FIG. 3, the determination results of S8 and S10 are Yes.

In S12, the determination unit 14 compares x coordinates of the upper right vertices of the finish area T and the bleed area B, and determines whether the former is larger than the latter (that is, the upper right vertex of the finish area T is located on the right side of the upper right vertex of the bleed area B). In a case where this determination result is positive (Yes), the upper right vertex of the finish area T is located outside of the rectangle of the bleed area B. This corresponds to an inappropriate positional relationship.

In S14, the determination unit 14 compares y coordinates of the upper right vertices of the finish area T and the bleed area B, and determines whether the former is larger than the latter (that is, the upper right vertex of the finish area T is located on the upper side of the upper right vertex of the bleed area B). In a case where this determination result is positive (Yes), the upper right vertex of the finish area T is located outside of the rectangle of the bleed area B. This corresponds to an inappropriate positional relationship.

In a case where the determination results of S8, S10, S12, and S14 are all No, the entire finish area T is included inside the bleed area B. In this case, the determination unit 14 determines that an inappropriate setting is not included in the page setting information of the print data (S16). The print control device 10 may generate display information indicating this determination result, and provide the generated information to the client device 30.

In a case where one or more determination results of S8, S10, S12, and S14 are Yes, at least a portion of the finish area T is located outside of the bleed area B. In this case, the determination unit 14 determines that an inappropriate setting is included in the page setting information of the print data. According to this determination, the error notification processing unit 16 may generate error notification information indicating that an error is present in the page setting information, and provide the generated information to the client device 30 (S18).

In this manner, the determination unit 14 compares the positions of four vertices of the outer circumference rectangle of the finish area with the positions of four vertices of the outer circumference rectangle of the bleed area, and thus determines whether at least a portion of the finish area is located outside of the bleed area.

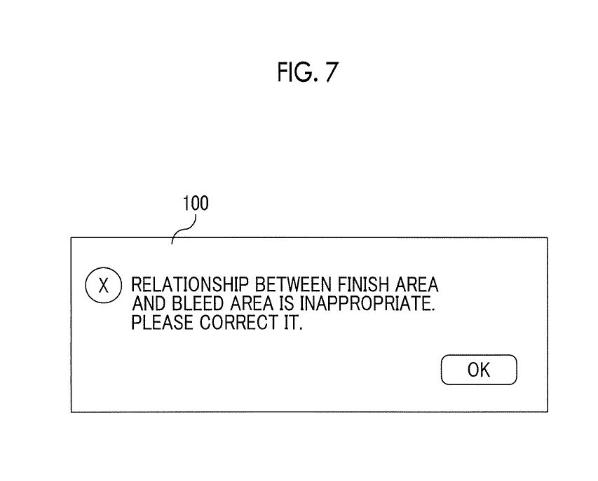

FIG. 7 shows an example of an error notification screen 100 indicated by this error notification information. A message indicating that a positional relationship between the finish area and the bleed area is inappropriate is displayed on this screen. The client device 30 displays the error notification screen 100 in the form of a dialogue, for example, on a UI screen for print management, on the basis of the error notification information notified from the error notification processing unit 16.

In the process of the determination unit 14 exemplified above, in a case where one of the finish area or the bleed area is not set, another area which is set is regarded as an area which is not set, and is used in the determination of the appropriateness of a positional relationship between the areas.

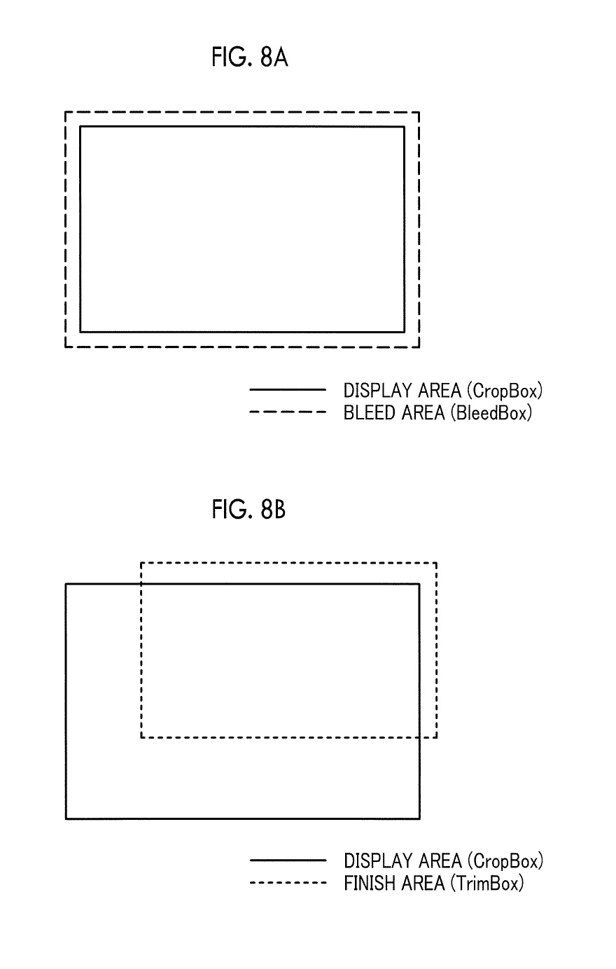

For example, in a case where the finish area is not set, the display area (CropBox) is used in the determination as the finish area when the display area is set, and the medium area (MediaBox) is used in the determination as the finish area when the display area is not set (see FIG. 6). For example, in a case where the finish area is not set, and the display area is set, it is determined that a positional relationship between the finish area (=display area) and the bleed area is inappropriate, as illustrated in FIG. 8A, in a case where at least a portion of the display area (four vertices of the outer circumferential rectangle in the shown example) regarded as the finish area is located outside of the bleed area.

Similarly, in a case where the bleed area is not set, the display area (CropBox) is used in the determination as the bleed area when the display area is set, and the medium area (MediaBox) is used in the determination as the bleed area when the display area is not set. For example, in a case where the bleed area is not set, and the display area is set, it is determined that a positional relationship between the finish area and the bleed area (=display area) is inappropriate, as illustrated in FIG. 8B, in a case where at least a portion of the finish area (upper right vertex the outer circumferential rectangle in the shown example) is located outside of at least a portion of the display area regarded as the bleed area.

The print control device 10 exemplified above is realized by, for example, causing a computer to execute a program indicating the aforementioned function of the device. Here, the computer has a circuit configuration in which, as hardware, for example, a microprocessor such as a CPU, a memory (primary storage) such as a random access memory (RAM) and a read-only memory (ROM), a controller that controls a secondary storage device such as a flash memory, a solid-state drive (SSD), or a hard disk drive (HDD), various types of input and output (I/O) interfaces, a network interface that performs control for connection with a network such as a local area network, and the like are connected to each other through, for example, a bus or the like. Programs having processing details of these respective functions described therein are saved in the secondary storage device such as a flash memory through a network or the like, and are installed in the computer. The programs stored in the secondary storage device are read out into the RAM and are executed by the microprocessor such as a CPU, whereby a function module group exemplified above is realized.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print data inspection device comprising:
a specification unit that specifies a finish area and a bleed area from page setting information of print data; and
a processing unit that executes a process for notifying a user of an error in a case where at least a portion of the finish area is located outside of the bleed area.

2. The print data inspection device according to claim 1, wherein in a case where a setting of the finish area is not included in the page setting information, the specification unit specifies a display area as the finish area when a setting of the display area is included in the page setting information, and specifies a medium area included in the page setting information as the finish area when the setting of the display area is not included in the page setting information.

3. The print data inspection device according to claim 1, wherein in a case where a setting of the bleed area is not included in the page setting information, the specification unit specifies the display area as the bleed area when the setting of the display area is included in the page setting information, and specifies the medium area included in the page setting information as the bleed area when the setting of the display area is not included in the page setting information.

4. The print data inspection device according to claim 2, wherein in a case where a setting of the bleed area is not included in the page setting information, the specification unit specifies the display area as the bleed area when the setting of the display area is included in the page setting information, and specifies the medium area included in the page setting information as the bleed area when the setting of the display area is not included in the page setting information.

5. A print data inspection system comprising:
a print device;
a print data inspection device that inspects print data printed by the print device; and
a client device that includes a display,
wherein the print data inspection device includes
a specification unit that specifies a finish area and a bleed area from page setting information of print data designated from the client device, and
a processing unit that transmits an error notification information displayed on the display to the client device, in a case where at least a portion of the finish area is located outside of the bleed area.

6. A non-transitory computer readable medium storing a program causing a computer to function as:
a unit that specifies a finish area and a bleed area from page setting information of print data; and
a unit that executes a process for notifying a user of an error in a case where at least a portion of the finish area is located outside of the bleed area.
